(19) United States
(12) Patent Application Publication
(10) Pub. No.: US 2026/0316309 A1
(43) Pub. Date: Oct. 15, 2026

(54) Compact flexible contour razor

(71) Applicant: Glissara LLC, Mankato, MN (US)

(72) Inventor: Masyn Olivia Xiaoying Rykhus, Mankato, MN (US)

(21) Appl. No.: 19/644,508

(22) Filed: Apr. 10, 2026

Related U.S. Application Data
(60) Provisional application No. 63/789,104, filed on Apr. 15, 2025.

(51) Int. Cl. B26B 21/52; B26B 21/22; B26B 21/40

(52) U.S. Cl. CPC B26B 21/527; B26B 21/225; B26B 21/4037

(57) ABSTRACT

A small, ergonomic razor wrapping around a user's fingertip, allowing the user to shave an area by using the natural movement of the hand and finger, rather than gripping a long handle. This razor is compact, curved, and designed specifically for grooming sensitive or contoured areas. The razor is configured to slide onto a user's finger(s) or portion of hand for easy use. Blades of the razor are smaller than standard razor blades and narrower, allowing the user to reach smaller, more intimate areas that cannot be otherwise reached and/or adequately maintained with traditional razor designs.

### CROSS-REFERENCE TO RELATED APPLICATION

This application claims priority to and the benefit of U.S. provisional application Ser. No. 63/789,104, filed on Apr. 15, 2025, the contents of which are incorporated in their entirety.

### FIELD OF THE INVENTION

The invention relates generally to personal grooming devices, and more specifically to razors designed for improved ergonomics and safety when shaving sensitive body areas, including the pubic region.

### BACKGROUND

Conventional razors typically consist of flat blades mounted on rigid handles, which are poorly suited for curved or sensitive regions of the human body. These designs often require awkward positioning, repeated passes, and lead to irritation, cuts, or ingrown hairs especially when shaving areas like the pubic region. There is a growing need for a safer, more adaptive razor that conforms to natural body contours while allowing greater control and comfort during grooming.

### SUMMARY

Aspects of the present disclosure relate to a small, ergonomic razor that wraps around a user's finger or fingertip, allowing the user to shave an area by using the natural movement of the hand and finger, rather than gripping a long handle. This razor is compact, curved, and designed specifically for grooming sensitive or contoured areas. Blades of the razor are smaller than standard razor blades and narrower, allowing the user to reach smaller, more intimate areas that cannot be otherwise reached and/or adequately maintained with traditional, square or rectangular razor designs.

Another aspect of the present disclosure relates to a compact razor configured to be worn over a finger, the compact razor comprising a tubular housing having a length and an open cavity therein for receiving the finger; an aperture in an upper end of the length on a first face thereof, the aperture configured for removably supporting a razor blade cartridge therein; and a fingertip grip positioned inside the open cavity and having a surface for coupling to the removable razor blade cartridge.

In one or more embodiments, the tubular housing is made of a flexible material.

In one or more embodiments, the tubular housing further comprises one or more slits along at least a portion of the length thereof such that the tubular housing provides an adjustable fit or one size fits most housing.

In one or more embodiments, the housing further comprises an opening in a top end thereof.

In one or more embodiments, the fingertip grip comprises a rough or textured grip surface on an interior face thereof for engaging with a fingertip of the finger inserted into the compact razor.

In one or more embodiments, the fingertip cap and the razor blade cartridge are coupled together via corresponding snap mechanisms which allow for a pivoting connection between the fingertip cap and the razor blade cartridge such that the razor blade cartridge can pivot when contacting a surface for hair removal.

In one or more embodiments, the compact razor further comprises a removable cap.

Yet another aspect of the present disclosure relates to a compact and flexible razor having a main body with an interior cavity configured to fit over a finger of a user and having an interior grip surface for engaging a fingertip of the user, wherein a rear surface of the interior grip surface is pivotally connected to a removable razor blade cartridge such that the main body carries the removable razor blade cartridge by movement of the finger inserted therein and wherein the main body has an opening along a length thereof and/or at a top portion thereof to allow the device to provide a one size fits most device.

In one or more embodiments, a removable cap for covering the razor blade cartridge and upper portion of the main body for storage and/or transport is provided.

In one or more embodiments, the main body is constructed from silicon, thermoplastic rubber, injection molded plastic, or combinations thereof.

In one or more embodiments, the interior grip surface comprises stretch silicone, elastic, rubber, or combinations thereof.

In one or more embodiments, the cap comprises aluminum coated in silicon.

Another aspect of the present disclosure relates to a method of hair removal comprising inserting a finger into a cavity in a housing supporting a razor blade cartridge; contacting a fingertip of the finger with a fingertip grip surface inside the housing; moving a hand with the finger to move the fingertip grip surface and housing with the razor blade cartridge along a surface for hair removal to remove said hair, wherein fingertip contact with the fingertip grip surface directs the razor blade cartridge angle as the razor blade cartridge is operably coupled to a rear surface of the fingertip grip surface.

In one or more embodiments the method comprises replacing the razor blade cartridge after one or more uses.

In one or more embodiments the method comprises coupling a cap to the housing to cover exposed blades of the razor blade cartridge for storage or transport.

### DRAWINGS

FIG. 1 is a front perspective view of a compact contour razor according to one or more embodiments described herein.

FIG. 2 is front perspective view of the compact contour razor with a cap thereon.

FIG. 3 a bottom view of the compact contour razor without the cap thereon.

FIG. 4A is a front view thereof with the razor blade removed therefrom, and FIG. 4B is a side view thereof.

FIGS. 5A-5C illustrate a fingertip cap portion of the compact contour razor. FIG. 5A illustrates an interior portion thereof where a finger pad rests, FIG. 5B is a side view thereof and FIG. 5C is a top view thereof.

FIGS. 6A-6D illustrate a razor blade body and razor blades for the compact contour razor. FIG. 6A is a side view of a razor blade cartridge for coupling to the razor via connection with a fingertip cap portion thereof, FIG. 6B is a top view showing the razor body supporting the razor blades, FIG. 6C is an isolated transparent view of the razor blades connected to the fingertip cap, and FIG. 6D is a front view of the razor blades.

FIG. 7 is a simplified illustration to show the contact between the razor blades and a user.

### DETAILED DESCRIPTION

Described herein is a hair removal device, a compact razor, generally described as having a curved or dome-shaped housing with integrated slots for retaining one or more blades. The device further comprises a hollow interior or grip mechanism that is generally sized to fit over a finger(s) or digit(s) of a user for use. The device housing can be constructed from various materials allowing exposure to water and soap as well as repeated uses without degradation, the materials comprising for example medical grade silicone and/or hard plastics or flexible thermoplastics. Generally, the device has dimensions which allow the user the ability to shave smaller areas using a natural and/or only finger motion, having control and reducing wrist strain from repeated motions.

What is meant by the term “razor” as used herein is a sharp-edged instrument used to shave or trim hair from the face or body. While embodiments described herein may be bladed tools primarily for use in the removal of body hair through the act of shaving using blade cartridges that may comprise a single blade, dual blade, or multi-blade construction, it is contemplated and within the scope of this disclosure that the device described herein could be adapted for use as a compact electric razor.

The device described herein comprises a main body, a fingertip cap, a razor blade portion that may be a replaceable razor blade and optional housing and blade cap. The fingertip cap may be removably connectable to the housing and comprise a lip which provide a snap-in feature for the fingertip cap. The finger cap is also configured to engage a portion of the razor where the removable razor blade is also engaged via a frictional and/or snapping engagement. The device also comprises a fingertip grip which may be a separate interior element and/or may be a surface of the fingertip cap in which a user directly contacts inside the main body to guide or move the main body by hand. The housing comprises an open interior cavity with an optional elongated body slot for adjustable sizing and an optional open top portion for finger sizing.

The design of the device as described in one or more embodiments herein improves accessibility of a user to hard-to-reach areas, reduces shaving pressure, and provides a more intuitive grooming experience. The device may be used in wet or dry conditions and is compact enough for travel.

In one or more embodiments, the device is a compact razor comprising a small, flexible outer housing or wrap constructed of a soft-touch material, examples of which include but are not limited to medical-grade silicone, thermoplastic elastomer (TPE), flexible polyurethane, or other materials.

In one or more embodiments, the device comprises a device cap for covering a top portion of the housing and/or covering blade(s) of the device for storage and/or transport. The cap may be comprised of the same or different materials from the housing. The cap may be comprised of one or more materials, for example a high polish aluminum material with a silicon finish. The cap may be configured to snap and/or otherwise frictionally engage with an upper end of the housing or lip thereof to retain the cap on the housing.

An upper portion of the device may comprise integrated or replaceable blade cartridges, oriented to follow a curved surface or straight blade(s). These blades may be secured in channels or embedded into slots molded into the housing. The blades may instead be provided in a cartridge that is removably connectable to the housing. An upper portion of the housing may also comprise an opening to an interior cavity of the housing to account for fingernail lengths.

In one or more embodiments a razor cartridge may be secured in the housing via a novel “popping” mechanism which allows a user to pop, click, or twist a replacement cartridge into place in the housing. The connection mechanism holds the razor cartridge on one or more points in a cavity which allows for the razor to pivot when in use and/or contour or mold to the user in order for the razor blade(s) of the cartridge to closely contact and follow the contour of the user's skin directed via the finger or fingers guiding the razor. This space may also be provided to allow for easy cleaning of the device after use, for example rinsing away hair and soap collected during use. Advantageously the connection mechanism may be located on multiple sides of the razor blade cavity such that the blade cartridge can be inserted and secured in at least two orientations, for example, the razor blade cartridge can be installed in a first direction and then removed and installed such that the direction of the blades (orientation) is flipped.

The housing may be provided with a slit or elongated opening alone one or more sides or portions thereof. This is a tension fitting. That is, the housing is made of a resilient but somewhat flexible material to the extent that a user may wear the housing by inserting a finger therein and the slit or slits allow for adjustable sizing by way of providing limited tension to the wearing the device to hold the device thereon.

The housing has a razor blade cartridge opening which may be configured to hold a razor blade cartridge that may comprise a single blade or multiple stacked blade cartridges with or without a moisturizing strip and with or without a guarding mechanism for the blades such as a blade cover or blade cap. The housing may then be provided with an additional removable safety cap and blade cover. Alternatively, the opening can be configured to hold one or more blades therein in a pivoting or fixed orientation without a cartridge.

The interior cavity is sized to allow the user to insert a finger, fingers, or part of the hand therein. The inner surface may include a gripping ridge, a friction layer, and/or elastic finger rings to ensure a stable fit during use. The fit may be secured via friction or grip. The design allows the user to shave by simply moving their finger, fingers, or part of the hand along the skin, bringing the housing and blades wrapped around the finger(s) therewith. This provides more precision and control than a traditional razor handle assembly. The flexible shape of the housing enables better contact with curved areas such as inner thighs, pubic region, underarms, or back of knees. The razor described herein can also be used in precision groom for professionals including salon stylists and barbers and can be used for professional and/or precision grooming including face, hair line, and use of the razor described herein is not limited in applicability to intimate areas. The device is compact in size and can be provided in varying sizes depending on end use needs.

In one or more embodiments, the blade(s) of the device may be replaceable. In one or more embodiments, the blades may be comprised of stainless steel, carbon steel, ceramic, or similar materials.

In one or more embodiments, the housing and one or more of its components may be comprised of silicon, thermoplastic rubber, injection molded plastic, or combinations thereof.

In one or more embodiments, a finger grip portion for holding the finger in contact with the housing may comprise an optional internal or external ring made of stretch silicone, elastic, elastic loop, or like materials.

In one or more embodiments, the device may further optionally comprise one or any combination of a moisture strip or skin conditioner embedded near the blade or location surrounding the blades; replaceable blade cartridge(s); one-size-fits-most finger sleeves and/or adjustable finger sleeves; additional size adjustments for different sized fingers; strap or similar adjustment mechanisms to allow users to adjust the size of housing for fit; a protective cap for travel or storage; and/or a vented interior to allow drying and/or mold/rust reduction for blades.

In one or more embodiments, the device may further comprise a single blade, dual blade and/or multi-blade configuration. The blade configuration and/or positioning may also be adjustable, allowing for blade angle to be adjusted and/or adjustable or floating. Blade tension may also be adjustable.

In one or more embodiments, the housing itself is resilient but flexible, such that the casing is flexible for purposes of conforming to body shapes. The outer shape of the housing may also be adjustable and/or flexible such that it can be adapted for applications for toe or foot care, facial grooming and/or general body hair removal. The housing and the blade cartridge being pivotable therein allows for the user to position the blade against the surface for hair removal in various positions, angles and pressures. For example, in one or more embodiments, the device can be configured and used in the manner of a straight razors, safety razors, cartridge razors or the like for hair removal of any type.

The device may also be configured with alternative housing shapes for different hand sizes, grip styles and user demands.

The device may also be configured with different external finishes. This could include color, sheen and/or external coatings or combinations thereof.

The housing may also be configured for one or more different optional attachments. For example, the device may be provided with attachments for physical abrading, exfoliation, massaging, and/or strips for moisturizing elements.

The housing as illustrated may be shown in a generally cylindrical shape to surround the digit or digits of a user, however alternative shapes are contemplated and within the scope of this disclosure as other geometric shapes and/or housings of increased flexibility and finger contour may be desired for different hand sizes and/or grip styles for various users.

Methods of use of the device of one or more embodiments described herein includes a user placing the razor housing over their index finger (or another preferred finger(s)). Once the housing is secured over the user's digit(s) (e.g., the digit inserted into the cavity), the user places their finger or hand along the skin in the desired shaving direction. User's finger movement allows greater precision and visibility especially in hard-to-reach or sensitive areas. Flexible nature and uniquely shaped housing thus glides over the skin while the blade edge trims hair at the surface. This reduces the user's wrist strain, improves control, and enhances safety, particularly for people with limited mobility or poor visibility during shaving.

The device described herein can be used to safely remove hair from various body locations with reduced risk of cuts or irritation. Additional benefits of the device described herein is a compact device that is a travel-friendly grooming tool. The device may additionally or alternatively be a precision grooming device based on its compact side and finger-controlled use. The tool may further be an ideal device for individuals with limited hand strength, grip strength, or mobility. The device is configured for use in both wet and dry environments and can be adapted for use on face, underarms, and/or other curved or non-curved body areas.

When worn and/or in use, the razor cartridge is positioned and/or placed and angled near a distal finger 40 joint so that placement of the blades on the skin 36 is intuitive and contact is flush for ease of hair removal.

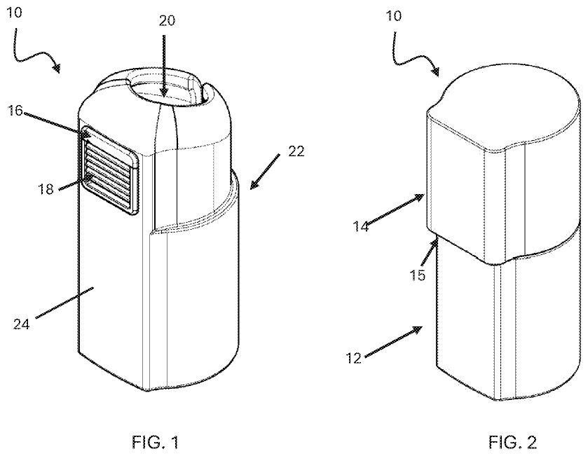

One embodiment of a compact and flexible device for hair removal that can be worn on a user's finger is shown in FIGS. 1-7. In the embodiment illustrated, the device 10 is a compact razor with a removable cap 14. The device has a main body 12 which supports a razor blade stack 18, referred to herein after as the razor blade(s) or razor blade cartridge.

The razor has a main body 12 which is configured to fit over a user's finger 40. The main body 12 has an open interior providing an inner cavity 20 which is configured to receive the user's digit or finger 40. A bottom of the device 10 is open so that a user inserts the finger 40 into a base of the device 10. The cavity 20 extends along a length of the main body 12. Also provided along the length of the main body, is a slot or opening 26 which allows the flexible main body to adapt to the user finger 40 of different sizes. The opening or slot 26 allows for adjustable size fitting of the device 10. The length of the main body 12 terminates at an upper end with an opening 19 which as illustrated is generally a rounded aperture in the top end of the device 10 which allows a user's finger to extend therethrough if needed and also provide venting to the cavity. The opening 19 in the embodiment illustrated is smaller in diameter than the opening in the base of the device 10 and this is smaller in diameter than the cavity 20 as the top of the main body 12 tapers to a rounded top end. It is contemplated and within the scope of this disclosure that the opening 19 may be the same size or larger than the cavity 20 for devices of different sizes and for different users. In the embodiment illustrated the device 10 is provided with rounded edges for comfort and lacks corners and sharp edges.

The main body 12 is also provided with a lip or a ledge 22 that extends circumferentially at least partially around the main body in order to support and couple the cap 14 to the device in a manner which covers the upper end of the device 10 and the razor blades 18. The cap 14 has a corresponding lip 15 that extends outwardly on a portion of the cap 14 that does not couple to the ledge 22 of the main body 12 which allows a user to easily remove the cap 14 by popping or sliding the cap 14 off of the main body 12. Other mechanisms for securing the cap to the main body are contemplated and within the scope of this disclosure including twist top caps, friction fit caps, snap tops and other mechanisms for coupling a cap or cover to a main body manually.

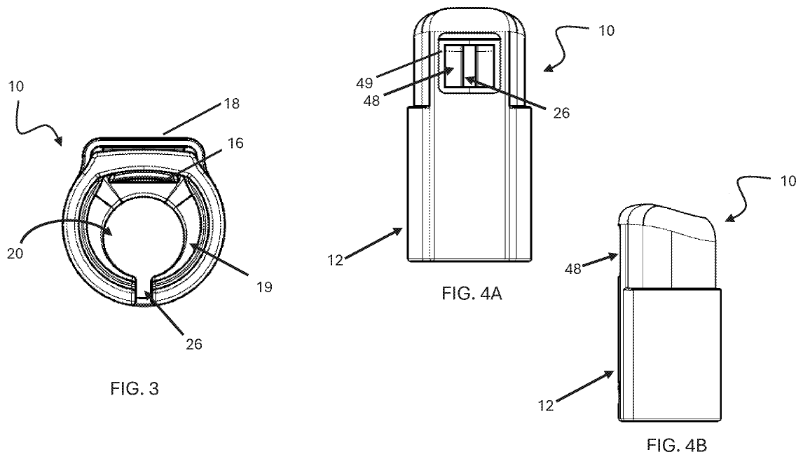

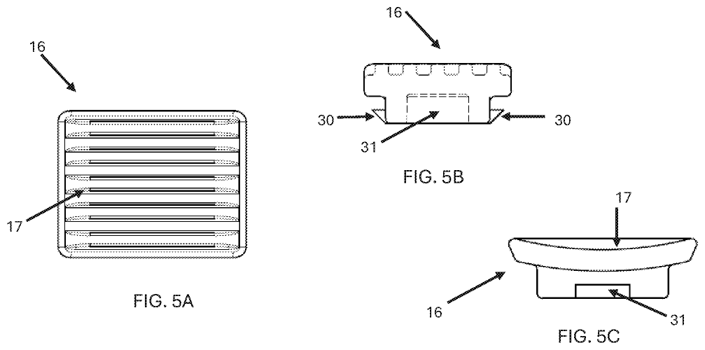

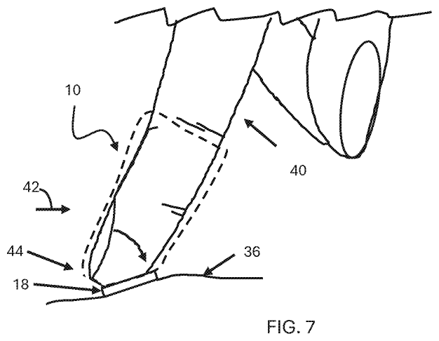

The main body 10 generally has a front face 24 which supports a fingertip cap 16 on an upper end there on and/or therein. The fingertip cap 16 as shown in further detail in FIGS. 5A-5C. The fingertip cap 16 is held by the main body 12 with a finger grip surface 17 oriented inwardly facing the cavity 20 of the main body so that a user's fingertip may directly contact the finger grip surface 17 for controlling the razor blades and razor main body 12 movement as shown in FIG. 7. That is, the fingertip cap 16 is provided with a textured surface at grip surface 17 that may be a silicon, rubber or otherwise textured surface and/or a smooth surface material with an increased co-efficient of friction to engage with the fingertip. The fingertip cap 16 is provided with snap on tabs 30 which allow the razor blades 18 to be secured to and securely (but removably) held by fingertip cap 16. The fingertip cap 16 is also provided with an opening 31 which may be used to collect or capture removed hair and can be rinsed out after use when installed in the device. The fingertip cap 16 couples to the main body 12 at the opening in the front face 24 of the main body 12. It may be held in place by way of a snap fit but may also be held in place by way of connection with the razor blades 18 which are positioned outside of the cavity such that one or more surfaces of the main body front face 24 at the opening are clamped between the razor blades and the fingertip cap 16, which allow the razor blades 18 and the fingertip cap 16 to pivot and/or adjust position when in use. Additionally or alternatively, the snap fit may be configured for statically holding the razor cartridge as installed such that the blade is installed in a static or fixed position on the razor. As shown in FIG. 4A, the upper end of the main body 12 has an opening 48 that has one or more surfaces 49 which provide a razor blade pocket 48 which support the fingertip cap 16 there behind as shown in FIG. 3 and the razor blades 18 there in front.

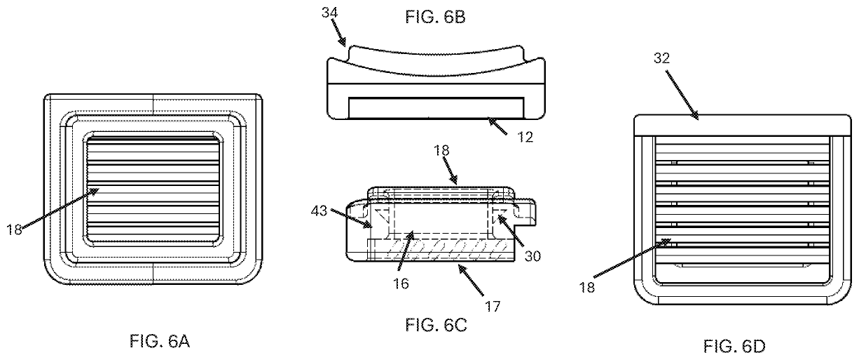

Pivotally and/or operably coupling to the fingertip cap 16 is a razor blade assembly 18 which is a replaceable razor blade cartridge also referred to as the razor blades 18. The razor blades 18 as shown in FIG. 6C are provided with snap features 43 which correspond to and couple to the snap features 30 of the fingertip cap 16 to couple the components together.

In assembly, the replaceable razor blades 18 are coupled to the fingertip cap 16 in the opening 48 in the main body 12 with the one or more surface supporting the razor blades 18 thereon and the fingertip cap 16 there behind. Blades of the razor are smaller than standard razor blades and narrower, but are angled and spaced in a manner consistent with specifications for safe hair removal in intimate spaces. With the fingertip grip surface 17 on the opposing side, the user has greater control over movement of the razor and blades when using the device.

For example, as shown in FIG. 7, as intuitively, most users will approach the skin 36 at a slight angle rather than at a complete 180 degrees (or 90 degrees), the razor 10 is now angled such that the blades 18 will follow a slight, natural curvature of the fingertip 44 of the digit 40 at the distal joint and allow the razor cartridge/blades 18 to be parallel and flush with the skin 36 as the razor is moved in a direction, for example along the direction of arrow 42.

Although the present disclosure has been described with reference to preferred embodiments, workers skilled in the art will recognize that changes may be made in form and detail without departing from the spirit and scope of the disclosure.

What is claimed:

1. A compact razor configured to be worn over at least one finger, the compact razor comprising:
a tubular housing having a length and an open cavity therein for receiving the finger;
an aperture in an upper end of the length on a first face thereof, the aperture configured for removable supporting a razor blade cartridge therein; and
a fingertip cap with grip positioned inside the open cavity and having a surface for coupling to the removable razor blade cartridge.

2. The compact razor of claim 1 wherein the tubular housing is made of a flexible material.

3. The compact razor of claim 1 wherein the tubular housing further comprises one or more slits along at least a portion of the length thereof such that the tubular housing provides an adjustable fit or one size fits most housing.

4. The compact razor of claim 1 and further comprising an opening in a top end of the tubular housing.

5. The compact razor of claim 1 wherein the fingertip grip comprises a rough or textured grip surface on an interior face thereof for engaging with a fingertip of the finger inserted into the compact razor.

6. The compact razor of claim 1 wherein the fingertip cap and the razor blade cartridge are coupled together via corresponding snap mechanisms which allow for a pivoting connection between the fingertip cap and the razor blade cartridge such that the razorblade cartridge can pivot when contacting a surface for hair removal.

7. The compact razor of claim 1 and further comprising a removable cap for the compact razor.

8. A compact and flexible razor having a main body with an interior cavity configured to fit over a finger of a user and having an interior grip surface for engaging a fingertip of the user, wherein a rear surface of the interior grip surface is pivotally connected to a removable razor blade cartridge such that the main body carries the removable razor blade cartridge by movement of the finger inserted therein and wherein the main body has an opening along a length thereof and/or at a top portion thereof to allow the device to provide a one size fits most device.

9. The compact and flexible razor of claim 8 and further comprising a fingertip cap supporting the interior grip surface and which pivotally connects the interior grip surface to the removable razor blade cartridge.

10. The compact and flexible razor of claim 8 and further comprising a removable cap for covering the razor blade cartridge and upper portion of the main body for storage and/or transport.

11. The compact and flexible razor of claim 10 wherein the main body is constructed from silicon, thermoplastic rubber, injection molded plastic, or combinations thereof.

12. The compact and flexible razor of claim 11 wherein the interior grip surface comprises stretch silicone, elastic, rubber, or combinations thereof.

13. The compact and flexible razor of claim 12 wherein the cap comprises aluminum coated in silicon.

14. A method of hair removal comprising:
inserting a finger into a cavity in a housing supporting a razor blade cartridge;
contacting a fingertip of the finger with a fingertip grip surface inside the housing;
moving a hand with the finger to move the fingertip grip surface and housing with the razor
blade cartridge along a surface for hair removal to remove said hair,
wherein fingertip contact with the fingertip grip surface directs the razor blade cartridge angle as the razor blade cartridge is operably coupled to a rear surface of the fingertip grip surface.

15. The method of claim 14 and further comprising replacing the razor blade cartridge after one or more uses.

16. The method of claim 14 and further comprising coupling a cap to the housing to cover exposed blades of the razor blade cartridge for storage or transport.
